(19) United States
(12) Patent Application Publication
(10) Pub. No.: US 2006/0276205 A1
(43) Pub. Date: Dec. 7, 2006

(54) Wireless communication terminals and methods that display relative positions of other wireless communication terminals

(76) Inventor: Henrik Bengtsson, Lund (SE)

Correspondence Address: MYERS BIGEL SIBLEY & SAJOVEC, P.A., P.O. BOX 37428, RALEIGH, NC, 27627, US

(21) Appl. No.: 11/142,524

(22) Filed: Jun. 1, 2005

(51) Int. Cl. H04Q 7/20

(52) U.S. Cl. 455/457; 455/456.1

(57) ABSTRACT

In a method of displaying on a first wireless communication terminal a relative position of a second wireless communication terminal, wireless signals are received directly from the second terminal. Distances between the first and second wireless communication terminals are measured based on strength of the received wireless signals when the first wireless communication terminal is at three or more different locations. Distances between the three or more different locations of the first wireless communication terminal are measured. Direction and distance between the first and second wireless communication terminals are measured based on the measured distances between the first and second wireless communication terminals and the measured distances between the three or more different locations of the first wireless communication terminal. A position of the second wireless communication terminal relative to the first wireless communication terminal is displayed on the first wireless communication terminal based on the determined direction and distance between the first and second wireless communication terminals.

### BACKGROUND OF THE INVENTION

The present invention relates to the field of communications in general and more particularly, to communication among a plurality of Bluetooth compatible wireless communication terminals.

As is well known to those having skill in the art, Bluetooth is a global standard that can eliminate a need for wires and cables for communication between both stationary and mobile communication terminals. Bluetooth compatible terminals can establish data and/or voice communications directly with other Bluetooth compatible terminals. A Bluetooth terminal can automatically setup an ad hoc network with other Bluetooth terminals. However, to be included within the network, the terminals typically need to be within a short range of about 100 meters of one another.

A person who is using a Bluetooth terminal may thereby exchange data, such as pictures, music/voice, electronic business cards, and text messages, with many proximately located persons who are using other Bluetooth terminals. While such data exchanges generally occur between persons who know each other, the technology is not limited thereto and can be used to communicate with unknown persons. In crowded areas, such as airport terminals and conference rooms, it may be difficult to identify a person with whom a Bluetooth connection has been established. Moreover, because such Bluetooth networks can established among many terminals, distinguishing among many persons who appear to be simultaneously using such Bluetooth terminals may be even more difficult.

### SUMMARY OF THE INVENTION

Some embodiments of the present invention provide a method of displaying on a first wireless communication terminal a relative position of a second wireless communication terminal. Wireless signals are received directly from the second terminal. Distances between the first and second wireless communication terminals are measured based on strength of the received wireless signals when the first wireless communication terminal is at three or more different locations. Distances between the three or more different locations of the first wireless communication terminal are measured. Direction and distance between the first and second wireless communication terminals are measured based on the measured distances between the first and second wireless communication terminals and the measured distances between the three or more different locations of the first wireless communication terminal. A position of the second wireless communication terminal relative to the first wireless communication terminal is displayed on the first wireless communication terminal based on the determined direction and distance between the first and second wireless communication terminals.

A user may thereby use the terminal to identify the presence of other terminals and to determine where they are located. Accordingly, when the terminal is connected through a wireless network with other terminals and is used in an area that is crowded with other persons who may appear to be also using terminals, the display of the relative locations of at least some of the connected terminals can assist the user in identifying and distinguishing presently connected terminals and users from among others that may be seen.

In some further embodiments, the wireless signal may be received through a Bluetooth transceiver in the first terminal. The distance between the first and second terminals may be estimated based on a defined relationship between a constant strength of the wireless signals that are transmitted by the second terminal, such as by the Bluetooth transceiver, and the strength of the received signals.

In some further embodiments, a command is received from a user of the first terminal to display a position of the second terminal relative to the first terminal. In response to the command, an indication is generated to the user to move the first terminal responsive to the command. The distances between the first and second wireless communication terminals are measured responsive to the command from the user and based on movement of the first wireless communication terminal through at least three different locations relative to the second wireless communication terminal and associated variation in the strength of the received signal.

In some further embodiments, bi-directional communications are established between the first terminal and a plurality of other wireless communication terminals. A command is received from a user of the first terminal to display a position of each of the other wireless communication terminals relative to the first terminal. An indication is generated to the user to move the first terminal. Distances between the first wireless communication terminal and the other wireless communication terminals are measured based on strength of the received wireless signals when the first wireless communication terminal is at three or more different locations, and a direction and distance between the first wireless communication terminal and the other wireless communication terminals is determined based on the measured distances between the first and other wireless communication terminals and the measured distances between the three or more different locations of the first wireless communication terminal. A position of the other wireless communication terminals relative to the first terminal is displayed on the first terminal based on the determined direction and distance between the first and other wireless communication terminals.

In some further embodiments, acceleration of the first wireless communication terminal is measured, such as through an accelerometer in the first wireless communication terminal, to generate acceleration information as it is moved between the three or more different locations. Distances between the three or more different locations of the first wireless communication terminal are determined based on the acceleration information.

In some further embodiments, the rotation of the first wireless communication terminal is measured, such as through a gyro and/or a magnetic compass in the first wireless communication terminal, as it is moved between the three or more different locations. The distances between the three or more different locations of the first wireless communication terminal are determined based on the acceleration information and based on the measured rotation.

In some further embodiments, the wireless signals can be received through a plurality of antennas to generate an associated plurality of received signals. The distances between the first and second wireless communication terminals can be measured based on strength of the plurality of received signals from the plurality of antennas.

In some further embodiments, the wireless signals can include information that identifies the second terminal, and at least some of the information can be displayed to a user of the first terminal. The information may identify a telephone number, name, and/or email address associated with the second terminal, and at least some of that information may be displayed to a user of the first terminal.

In some other embodiments, a first wireless communication terminal includes a receiver, a display, and a position determination unit. The receiver is configured to receive wireless signals directly from a second wireless communication terminal. The position determination unit is configured to measure distances to the second wireless communication terminal based on strength of the received wireless signals when the first wireless communication terminal is at three or more different locations, configured to measure distances between the three or more different locations of the first wireless communication terminal, configured to determine a direction and distance to the second wireless communication terminal based on the measured distances to the second wireless communication terminal and the measured distances between the three or more different locations of the first wireless communication terminal, and configured to illustrate on the display a position of the second wireless communication terminal relative to the first wireless communication terminal based on the determined direction and distance to the second wireless communication terminal.

In some further embodiments, the receiver can include a Bluetooth receiver that is configured to receive Bluetooth formatted signals from the second terminal.

In some further embodiments, the position determination unit is further configured to measure strength of the wireless signal received when the first wireless communication terminal is at the three or more different locations, and to measure distances to the second wireless communication terminal based on changes in the measured strengths of the received wireless signals.

In some further embodiments, the position determination unit includes an accelerometer that is configured to generate acceleration information based on acceleration of the first wireless communication terminal, and is further configured to determine the distances between the three or more different locations of the first wireless communication terminal based on the acceleration information. The position determination unit may include a gyro and/or a magnetic compass that is configured to measure rotation of the first wireless communication terminal as it is moved between the three or more different locations, and the position determination unit is further configured to determining the distances between the three or more different locations of the first wireless communication terminal based on the acceleration information and based on the measured rotation.

In some further embodiments, the first terminal may include a plurality of antennas. The receiver can be connected to the plurality of antennas and configured to generate a plurality of received signals in response to the wireless signals that are incident to the plurality of antennas. The position determination unit can be further configured to measure the distances between the first and second wireless communication terminals based on strength of the plurality of received signals from the plurality of antennas.

In some further embodiments, the position determination unit can be further configured to identify information, such as a telephone number, name, and/or email address associated with the second terminal, that is contained in the wireless signals, and to illustrate at least some of the information on the display.

### BRIEF DESCRIPTION OF THE DRAWINGS

FIG. 1 is a block diagram that illustrates a wireless communication system that includes a plurality of wireless communication terminals, at least one of which is configured to display the relative position of at least one of the other terminals in accordance with some embodiments of the present invention.

FIG. 2 is a block diagram that illustrates a wireless communication terminal according to some embodiments of the invention.

FIG. 3 is a block diagram that illustrates the terminal of FIG. 2 in further detail in accordance with some embodiments of the invention.

FIG. 4 is a flowchart that illustrates operations for displaying on a wireless communication terminal the relative position of at least one other wireless communication terminal based on movement of the terminal in accordance with various embodiments of the invention.

### DETAILED DESCRIPTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present invention. In addition, as used herein, the singular forms “a”, “an” and “the” are intended to include the plural forms as well, unless the context clearly indicates otherwise.

It also will be understood that, as used herein, the term “comprising” or “comprises” is open-ended, and includes one or more stated elements, steps and/or functions without precluding one or more unstated elements, steps and/or functions. As used herein the term “and/or” includes any and all combinations of one or more of the associated listed items. It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation. Like numbers refer to like elements throughout.

Embodiments according to the present invention are described with reference to block diagrams and/or operational illustrations of methods, wireless communication terminals, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. Computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

As used herein, a “wireless communication terminal” includes, but is not limited to, a terminal that is configured to receive communication signals via a short range wireless interface from, for example, a Bluetooth wireless interface, a wireless local area network (WLAN) interface such as IEEE 801.1 la-g, and/or an optical interface such as infra-red. Example wireless communication terminals include, but are not limited to, a cellular phone that is configured to communicate with a cellular network and with other terminals over a Bluetooth interface, WLAN interface, other RF interface, and/or optical interface; a personal data assistance (PDA) that is configured to communicate over a Bluetooth interface, WLAN interface, other RF interface, and/or optical interface; and a mobile or fixed computer or other device that is configured to communicate over a Bluetooth interface, WLAN interface, other RF interface, and/or optical interface.

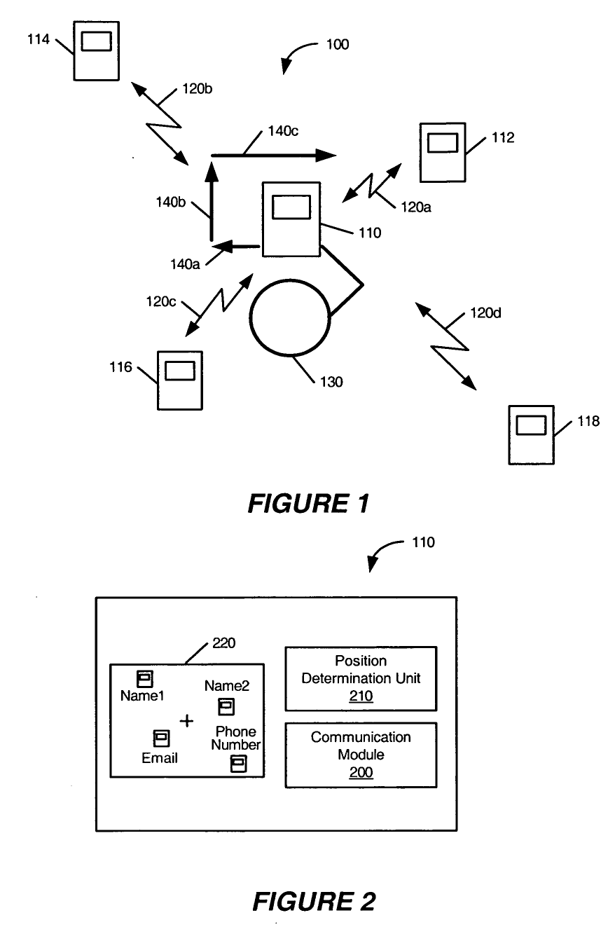

FIG. 1 is a schematic block diagram of a wireless communication system 100 that includes a plurality of a wireless communication terminals 110, 112, 114, 116, 118. Terminal 110 is configured to display the position of the other terminals 112, 114, 116, 118 relative to itself in accordance with some embodiments of the present invention.

FIG. 2 is a schematic block diagram of the terminal 110 in accordance with some embodiments of the present invention. The terminal 110 can include a communication module 200, a position determination unit 210, and a display 220. With reference to FIGS. 1 and 2, the communication module 200 is configured to receive communication signals from the other terminals 112, 114, 116, 118 over wireless interfaces 120a-d that are established directly therebetween. The communication module 200 may include a Bluetooth module, a wireless local area network (WLAN) module which may be compliant with, for example, IEEE 801.11a-g, and/or an optical communication module. The communication module 200 may thereby communicate with the other terminals 112, 114, 116, 118 over short ranges, which may be less than about several hundred meters for a WLAN type module 200 or less than about a 100 meters for a Bluetooth type module 200.

The position determination unit 210 is configured to measure distances between the terminal 110 and the other terminals 112, 114, 116, 118 based on the strength of wireless signals that are received from the other terminals 112, 114, 116, 118 when the terminal 110 is at three or more different spaced apart locations. The terminal 110 measures distances between the three or more different locations of the first wireless communication terminal. The terminal 110 determine a direction and distance to the other terminals 112, 114, 116, 118 based on the measured distances to the other terminals 112, 114, 116, 118 and the measured distances between the three or more different locations. The terminal 110 can then illustrate on a display a position of the other terminals 112, 114, 116, 118 relative to the terminal 110 based on the determined direction and distance to the other terminals 112, 114, 116, 118. Operation of the position determination unit 210 in accordance with various embodiments of the present invention will be discussed in more detail further below.

The terminal 110 illustrates on the display 220 the determined positions of the other terminals 112, 114, 116, 118 (represented by the same graphical icons as shown on FIG. 1) relative to itself (represented by “+”). The communication signal received from each of the other terminals 112, 114, 116, 118 can contain information that identifies those terminals 112, 114, 116, 118, and which may also be illustrated on the display 220. For example, as illustrated within the display 220 of FIG. 2, the received signals may identify a telephone number of a terminal, a name of the terminal/user, and/or an email address of the terminal. Such information may be displayed adjacent to the associated terminal.

The user 130 may thereby use the terminal 110 to identify the presence of the other terminals 112, 114, 116, 118 and to determine where they are located. Accordingly, when the terminal 110 is connected through a wireless network with other terminals and is used in an area that is crowded with other persons who may appear to be also using terminals, displaying the relative locations of at least some of the connected terminals can assist the user 130 in identifying and distinguishing presently connected terminals and users from among others that may be seen.

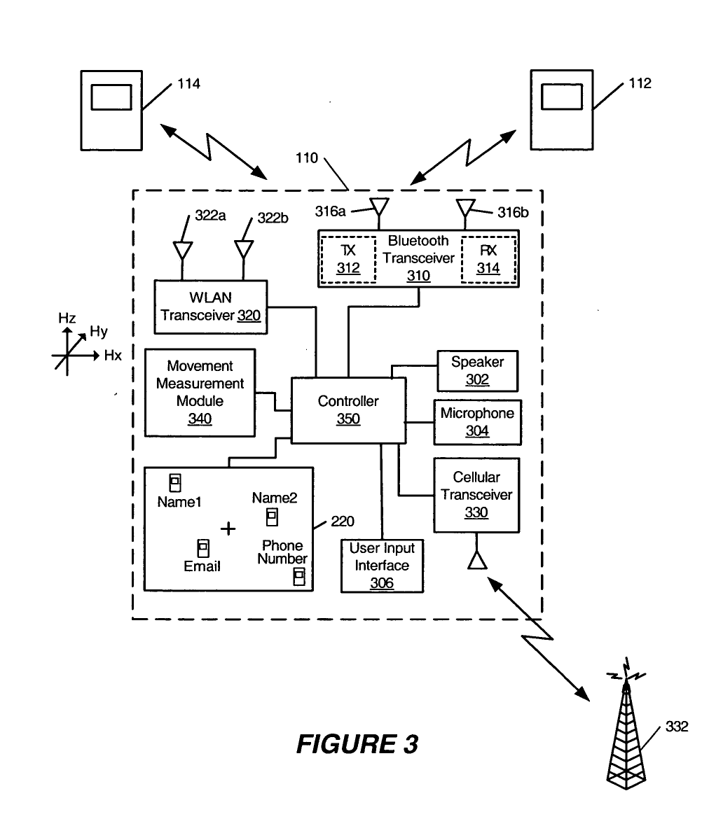

Some further embodiments of the terminal 110 will now be described with reference to FIG. 3. As shown in FIG. 3, the terminal 110 may further include a speaker 302 and microphone 304 to enable a user to establish voice communications through the terminal 110, and may include a user input interface 306 to enable receipt of commands and/or other input from a user.

The communication module 200 may include a Bluetooth transceiver 310 and/or a WLAN transceiver 320, and may include a cellular transceiver 330. The Bluetooth transceiver 310 typically includes both a transmitter (TX) 312 and a receiver (RX) 314 to allow bi-directional communications, but the present invention is not limited to such transceivers and, as used herein, a “transceiver” may include only a receiver. The terminal 110 may thereby communicate with the other terminals 112, 114, 116, 118 through the Bluetooth transceiver 310 and one or more associated antennas 316a-b using the Bluetooth protocol and signals that are formatted in accordance therewith. The terminal 110 may alternatively or additional communicate with the terminals 112, 114, 116, 118 through the WLAN transceiver 320 and one or more associated antennas 322a-b using one or more of WLAN protocols, such as for example IEEE 802.11a-g.

Terminal 110 may communicate with a cellular network 332 via the cellular transceiver 330 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). Communication protocols as used herein may specify the information communicated, the timing, the frequency, the modulation, and/or the operations for setting-up and/or maintaining a communication connection.

The terminal 110 may also include a movement measurement module 340 and a controller 350. The Bluetooth transceiver 310 and/or the WLAN transceiver 320, the movement measurement module 340, and the controller 350 may form the position determination unit 210 of FIG. 2.

The movement measurement module 340 measures movement of the terminal 110, and generates a signal that indicates a varying position of the terminal 110 as it is moved and/or that indicates a varying direction of the terminal 110 as it is rotated. The module 340 may include an accelerometer(s), a gyro(s), and/or a magnetic compass. Although only one module 340 is shown, it is to be understood that it may measure acceleration and/or rotation in one or more directions (e.g., relative to the axes Hx, Hy, Hz shown in FIG. 3). The module 340 generates a signal that the controller 350 uses to determine how far the terminal 110 has been moved and/or how far it has been rotated.

The controller 350 may estimate its distance from another terminal based on a defined relationship between an expected strength of the signal transmitted by the other terminal, the strength of the received signal, and the distance between terminal 110 and the other terminal. For example, Bluetooth terminals and WLAN terminals can be expected to transmit with a relatively constant signal strength. Accordingly, a relationship may be defined by which the terminal 110 can determine the distance between the terminal 110 and the transmitting terminal based on the expected transmitted signal strength and the received signal strength. Based on the transmission pattern and associated gain of the transmitting antenna(s), the transmitted and received signal strength may be related by the distance squared or the distance cubed. The effect of obstructions between terminal 110 and a transmitting terminals and/or multi-path effects on the received signal may be detected and compensated for to improve the distance estimation.

With reference to FIGS. 1 and 3, the average strength of the signals that are received by terminal 110 from terminal 112 should increase as terminal 110 is moved closer to terminal 112, and should decrease as terminal 110 is moved further away. The strength of the signals received from the other terminals 114, 116, 118 should vary in a similar way as the terminal 110 is moved relative to the other terminals 114, 116, 118. The controller 350 can measured distance and direction between the terminal 110 and each of the terminals 112, 114, 116, 118 based on measurement of the variation in the strength of the received signal from each of the terminals 112, 114, 116, 118 when the terminal 110 is moved relative thereto by the user 130, and based on measurement of the distance that the terminal 110 has been moved between the signal strength measurement.

For example, the user 130 may move the terminal 110 along the exemplary paths 140a-c (FIG. 1) through four locations (e.g., start location, end of path 140a, end of path 140b, and end of path 140c) while the controller 350 measures the distance that the terminal 110 has been moved, based on acceleration information from accelerometer(s) in the movement measurement module 340, and the associated strength (variation in strength) of the signals that are received from the terminals 112, 114, 116, 118.

The gyro(s) and/or magnetic compass in the module 340 can measure rotation of the terminal 110 as it is moved along paths 140a-c (FIG. 1). The controller 350 can combine the measured rotation with the measured acceleration of the terminal 110 to determine more accurately where the terminal 110 is located when measurements are made of the strength of received signals.

The controller 350 can measure distances to the terminals 112, 114, 116, 118 based on the measured strengths of the wireless signals that are received therefrom, and can determine a direction and distance to each of the terminals 112, 114, 116, 118 based on the variation in the measured strength of the received signals and the associated distances that the terminal 110 has been moved between the received signal strength measurements.

The controller 350 can then display on the display 220 the position of the terminals 112, 114, 116, 118 relative to the terminal 110 based on the determined direction and distance to the terminals 112, 114, 116, 118.

With continuing reference to FIGS. 1 and 3, the strength of the signals that are received by terminal 110 from terminal 112 may also vary based on the relative orientation between the antennas of the two terminals 110, 112. For example, the antennas 316a-b, 322a-b can have a gain pattern that varies based on an incident angle of the received signal. Consequently, the strength of the signal that is received from each of the terminals 112, 114, 116, 118 can vary as the terminal 110 is rotated relative to them.

In accordance with some embodiments of the present invention, the transceivers 310 and/or 320 are configured to generate a plurality of received signals in response to the wireless signals incident to the antennas 316a-b and/or 322a-b, respectively. The controller 350 can be configured to measure the distances between the first and second wireless communication terminals based on the strength of the signals from the plurality of antennas. Accordingly, the controller 350 may be able to use diversity reception from the antenna pairs 316a-b and/or 322a-b to improve its measurement of the distances to the terminals 112, 114, 116, 118 based on received signal strength by removing from the measurements any variation in the received signal strength that is due to rotation of the terminal 110 relative to the terminals 112, 114, 116, 118.

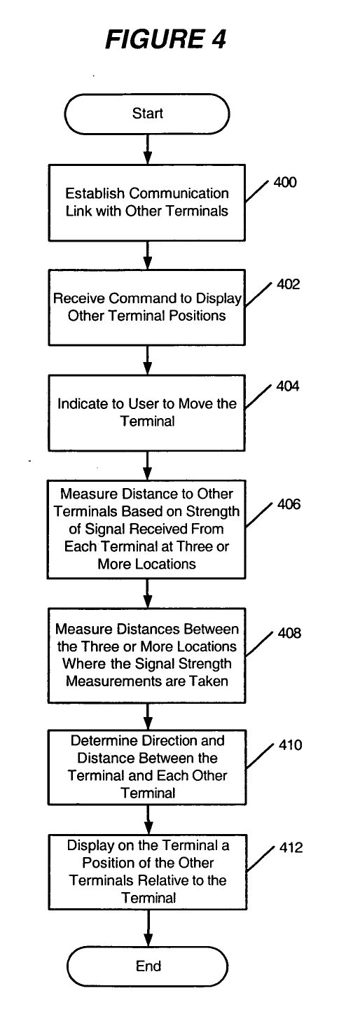

FIG. 4 is a flowchart that illustrates operations for determining and displaying on a first terminal the relative position of one or more other terminals based on movement of the first terminal, in accordance with various embodiments of the invention. At Block 400, a communication link is established between the first terminal and the other terminals. A command is received at Block 402 from a user of the first terminal to display the relative positions of the other terminals. The first terminal generates an indication to the user at Block 404 to move the terminal relative to the other terminals. Responsive to the first terminal being moved by the user, the distance to each of the other terminals is measured at Block 406 based on the strength of signals that are received from each of the terminals when the first terminal is at three or more different locations. At Block 408, measurements are made of the distances between the three or more location where the received signal strength measurements were taken. The direction and distance between the first terminal and each of the other terminals is determined at Block 410 based on the measured distances between the three or more different locations and the measured distances between the first terminal and the other terminals. The positions of the other terminals relative to the first terminal are displayed on the terminal at Block 412 based on the determined direction and distance from Block 410.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for displaying on a first wireless communication terminal a relative position of a second wireless communication terminal, the method comprising:
receiving at the first wireless communication terminal wireless signals directly from the second wireless communication terminal;
measuring distances between the first and second wireless communication terminals based on strength of the received wireless signals when the first wireless communication terminal is at three or more different locations;
measuring distances between the three or more different locations of the first wireless communication terminal;
determining a direction and distance between the first and second wireless communication terminals based on the measured distances between the first and second wireless communication terminals and the-measured distances between the three or more different locations of the first wireless communication terminal; and
displaying on the first wireless communication terminal a position of the second wireless communication terminal relative to the first wireless communication terminal based on the determined direction and distance between the first and second wireless communication terminals.

2. The method of claim 1, wherein receiving at the first wireless communication terminal wireless signals directly from the second wireless communication terminal comprises receiving through a Bluetooth transceiver in the first wireless communication terminal Bluetooth formatted signals from the second wireless communication terminal.

3. The method of claim 1, wherein measuring distances between the first and second wireless communication terminals comprises measuring distance between the first and second wireless communication terminals based on a defined relationship between a constant strength of the wireless signals transmitted by the second wireless communication terminal and the strength of the received wireless signals.

4. The method of claim 1, further comprising:
receiving a command from a user of the first wireless communication terminal to display a position of the second wireless communication terminal relative to the first wireless communication terminal; and
generating an indication to the user to move the first wireless communication terminal, and wherein measuring distances between the first and second wireless communication terminals is responsive to the command from the user and is based on movement of the first wireless communication terminal through at least three different locations relative to the second wireless communication terminal and associated variation in the strength of the received signal.

5. The method of claim 1, further comprising:
establishing bi-directional communications between the first wireless communication terminal and a plurality of other wireless communication terminals;
receiving a command from a user of the first wireless communication terminal to display a position of each of the other wireless communication terminals relative to the first wireless communication terminal;
generating an indication to the user to move the first wireless communication terminal;
measuring distances between the first wireless communication terminal and the other wireless communication terminals based on strength of the received wireless signals when the first wireless communication terminal is at three or more different locations;
determining a direction and distance between the first wireless communication terminal and the other wireless communication terminals based on the measured distances between the first and other wireless communication terminals and the measured distances between the three or more different locations of the first wireless communication terminal; and
displaying on the first wireless communication terminal a position of the other wireless communication terminals relative to the first wireless communication terminal based on the determined direction and distance between the first and other wireless communication terminals.

6. The method of claim 1, wherein measuring distances between the three or more different locations of the first wireless communication terminal comprises:
measuring acceleration of the first wireless communication terminal to generate acceleration information as it is moved between the three or more different locations; and
determining distances between the three or more different locations of the first wireless communication terminal based on the acceleration information.

7. The method of claim 6, wherein measuring acceleration of the first wireless communication terminal comprises generating the acceleration information through an accelerometer in the first wireless communication terminal.

8. The method of claim 6, further comprising:
measuring rotation of the first wireless communication terminal as it is moved between the three or more different locations; and
determining distances between the three or more different locations of the first wireless communication terminal based on the acceleration information and based on the measured rotation.

9. The method of claim 8, wherein measuring rotation of the first wireless communication terminal comprises measuring rotation through a gyro and/or a magnetic compass in the first wireless communication terminal.

10. The method of claim 1, wherein:
receiving at the first wireless communication terminal wireless signals directly from the second wireless communication terminal comprises receiving the wireless signals through a plurality of antennas to generate an associated plurality of received signals; and
measuring distances between the first and second wireless communication terminals comprises measuring the distances between the first and second wireless communication terminals based on strength of the plurality of received signals from the plurality of antennas.

11. The method of claim 1, wherein the wireless signals comprises information that identifies the second wireless communication terminal, and further comprising displaying at least some of the information to a user of the first wireless communication terminal.

12. The method of claim 11, wherein:
the information identifies a telephone number, name, and/or email address associated with the second wireless communication terminal; and
displaying at least some of the information to a user of the first wireless communication terminal comprises displaying the telephone number, name, and/or email address.

13. A first wireless communication terminal comprising:
a receiver that is configured to receive wireless signals directly from a second wireless communication terminal;
a display;
a position determination unit that is configured to measure distances to the second wireless communication terminal based on strength of the received wireless signals when the first wireless communication terminal is at three or more different locations, configured to measure distances between the three or more different locations of the first wireless communication terminal, configured to determine a direction and distance to the second wireless communication terminal based on the measured distances to the second wireless communication terminal and the measured distances between the three or more different locations of the first wireless communication terminal, and configured to illustrate on the display a position of the second wireless communication terminal relative to the first wireless communication terminal based on the determined direction and distance to the second wireless communication terminal.

14. The first wireless communication terminal of claim 13, wherein the receiver comprises a Bluetooth receiver that is configured to receive Bluetooth formatted signals from the second wireless communication terminal.

15. The first wireless communication terminal of claim 13, wherein the position determination unit is further configured to measure strength of the wireless signal received when the first wireless communication terminal is at the three or more different locations, and to measure distances to the second wireless communication terminal based on changes in the measured strengths of the received wireless signals.

16. The first wireless communication terminal of claim 13, wherein:
the position determination unit comprises an accelerometer that is configured to generate acceleration information based on acceleration of the first wireless communication terminal, and is further configured to determine the distances between the three or more different locations of the first wireless communication terminal based on the acceleration information.

17. The method of claim 16, wherein:
the position determination unit comprises a gyro and/or a magnetic compass that is configured to measure rotation of the first wireless communication terminal as it is moved between the three or more different locations, and is further configured to determining the distances between the three or more different locations of the first wireless communication terminal based on the acceleration information and based on the measured rotation.

18. The first wireless communication terminal of claim 13, further comprising a plurality of antennas, and wherein:
the receiver is connected to the plurality of antennas and configured to generate a plurality of received signals in response to the wireless signal incident to the plurality of antennas; and
the position determination unit is further configured to measure the distances between the first and second wireless communication terminals based on strength of the plurality of received signals from the plurality of antennas.

19. The first wireless communication terminal of claim 13, wherein the position determination unit is further configured to identify information contained in the wireless signals that identifies the second wireless communication terminal, and to illustrate on the display at least some of the information.

20. The first wireless communication terminal of claim 19, wherein the position determination unit is further configured to identify a telephone number, name, and/or email address associated with the second wireless communication terminal in response to the wireless signals, and to illustrate on the display the identified telephone number, name, and/or email address.
